(19) United States
(12) Patent Application Publication
(10) Pub. No.: US 2018/0024998 A1
(43) Pub. Date: Jan. 25, 2018

(54) INFORMATION PROCESSING APPARATUS, INFORMATION PROCESSING METHOD, AND PROGRAM

(71) Applicant: NEC Personal Computers, Ltd., Tokyo (JP)

(72) Inventor: Tsuyoshi Takemoto, Tokyo (JP)

(73) Assignee: NEC Personal Computers, Ltd., Tokyo (JP)

(21) Appl. No.: 15/615,119

(22) Filed: Jun. 6, 2017

(30) Foreign Application Priority Data
Jul. 19, 2016 (JP) 2016141916

(51) Int. Cl. G06F 17/30; G06F 17/27

(52) U.S. Cl. CPC G06F 17/30011; G06F 17/2715; G06F 17/3053; G06F 17/30554

(57) ABSTRACT

The present invention provides an information processing apparatus capable of identifying a service providing site associated with information being viewed by a user. The information processing apparatus includes: a service providing site database configured to include terms, in the form of words, appearing on a service providing site that provides a commercial product, service, or information via a network; a term extraction section that extracts each term from a viewing document being viewed by a user; and a service providing site identifying section that identifies a service providing site associated with the viewing document based on a feature value stored in the service providing site database in association with each extracted term.

### FIELD OF THE INVENTION

The present invention relates to an information processing apparatus, an information processing method, and a program.

### BACKGROUND OF THE INVENTION

Recently, enormous amounts of information and data have been provided from the Internet and broadcast networks, and the kinds of provided information have also been diversified. Further, the number of users to acquire information from the Internet and broadcast networks has increased. In such a situation, there is already known a system in which a provider providing contents using the Internet or broadcast networks collects the history of each user to access the Internet and the like, analyzes a taste of each user based on the collected access history, and recommends a content that matches the analyzed taste.

A technique associated with such a content recommendation system mentioned above is disclosed, for example, in Patent Document 1. Patent Document 1 discloses a technique for preparing a table, in which history information and user-specific information are associated with each other to be able to follow changes in user's taste, to reflect user history information in the table in order to provide information beneficial to the user.

[Patent Document 1] Japanese Patent Application Publication No. 2009-087155

### SUMMARY OF THE INVENTION

However, for example, the conventional technique disclosed in Patent Document 1 is basically to acquire a content based on the acquired history information and provide the content to the user, but there is no mention about the kind of service providing site (a commercial product providing site, a video/music distribution site, or the like) from which the content is acquired. When the content is acquired based on the history information, accessing service providing sites in all categories results in increasing the load on the apparatus. Further, the content acquired in such a way may include information different from that intended by the user.

The present invention has been made in view of the above circumstances, and it is an object thereof to provide an information processing apparatus capable of identifying a service providing site associated with information viewed by a user.

An information processing apparatus according to the present invention includes: a service providing site database configured to include terms, in the form of words, appearing on a service providing site that provides a commercial product, service, or information via a network; a term extraction section that extracts each of the terms from a viewing document being viewed by a user; and a service providing site identifying section that identifies a service providing site associated with the viewing document based on a feature value stored in the service providing site database in association with the extracted term.

An information processing method according to the present invention includes: generating a service providing site database configured to include terms, in the form of words, appearing on a service providing site that provides a commercial product, service, or information via a network; extracting each of the terms from a viewing document being viewed by a user; and identifying a service providing site associated with the viewing document based on a feature value stored in the service providing site database in association with the extracted term.

A program for carrying out information processing according to the present invention, causing a computer to execute: generating a service providing site database configured to include terms, in the form of words, appearing on a service providing site that provides a commercial product, service, or information via a network; extracting each of the terms from a viewing document being viewed by a user; and identifying a service providing site associated with the viewing document based on a feature value stored in the service providing site database in association with the extracted term.

According to the present invention, a service providing site associated with information viewed by a user can be identified.

### BRIEF DESCRIPTION OF THE DRAWINGS

FIG. 1 is a hardware configuration diagram of an information processing apparatus 1 according to an embodiment of the present invention.

FIG. 2 is a functional block diagram of the information processing apparatus 1 according to the embodiment of the present invention.

FIG. 3 is a table as an example of a service providing site database according to the embodiment of the present invention.

FIG. 4 is a diagram illustrating an example of a viewing document according to the embodiment of the present invention.

FIG. 5 is a table illustrating an example of text analysis of the viewing document according to the embodiment of the present invention.

FIG. 6 is a table illustrating an example of a degree of similarity between the viewing document and each service providing site according to the embodiment of the present invention.

FIG. 7 is a table illustrating an example of identifying a service providing site based on the degree of similarity according to the embodiment of the present invention.

FIG. 8 is a table illustrating an example of a database generated by clustering documents accessible via a network according to the embodiment of the present invention.

FIG. 9 is a table as a database in which the appearance frequency of each term appearing in the database generated by clustering the documents is associated with the appearance frequency on each service providing site according to the embodiment of the present invention.

FIG. 10 is a table illustrating an example of identifying a service providing site based on the degree of interest in each service providing site with respect to the database generated by clustering the documents according to the embodiment of the present invention.

FIG. 11 is a diagram illustrating an example of identifying a term cluster based on the identified service providing site according to the embodiment of the present invention.

FIG. 12 is a table illustrating an example of selecting a keyword according to the embodiment of the present invention.

FIG. 13 is an example of a flowchart for identifying a service providing site based on the degree of similarity according to the embodiment of the present invention.

FIG. 14 is an example of a flowchart for identifying a service providing site based on the degree of interest according to the embodiment of the present invention.

### DETAILED DESCRIPTION OF THE INVENTION

An embodiment of the present invention will be described in detail below.

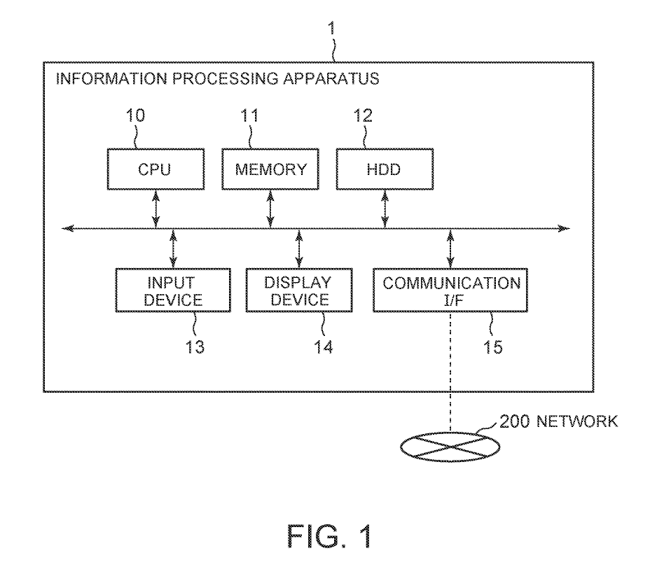

Referring first to FIG. 1, the hardware configuration of an information processing apparatus 1 of the embodiment will be described. Here, the information processing apparatus is an information terminal connectable to a network, such as a personal computer, a tablet terminal, or a smartphone, or may be a host computer that originates a processing request to multiple computers through a network. Note that the configuration of the information processing apparatus 1 is not necessarily required to have the same configuration as that illustrated in FIG. 1, and it is only necessary to include hardware capable of implementing the embodiment. For example, an input device 13 and a display device 14 are not indispensable components, and an optical drive or the like to read and write data stored on a CD or a DVD may be provided.

The information processing apparatus 1 includes a CPU 10 that executes a predetermined program to control the entire information processing apparatus 1, a memory 11 composed of a read-only nonvolatile memory, such as a mask ROM, an EPROM, or an SSD, which stores a program to be read by the CPU 10 when the information processing apparatus 1 is powered on, and a working volatile memory, such as an SRAM or a DRAM, used by the CPU 10 to read the program and temporarily write data generated by arithmetic processing or the like, an HDD 12 capable of holding various data records when the information processing apparatus 1 is powered off, the input device 13 composed of a mouse and input keys, and the display device 14 provided with a display using panels such as liquid crystal and organic EL.

The information processing apparatus 1 further includes a communication I/F 15. The information processing apparatus 1 is connected to a network 200 through the communication I/F 15. The communication I/F 15 is to access various pieces of information accessible via the network 200 based on the operation of the CPU 10. Specific examples of the communication I/F 15 include a USB port, a LAN port, and a wireless LAN port, and any port may be used as long as the communication I/F 15 can exchange data with external devices.

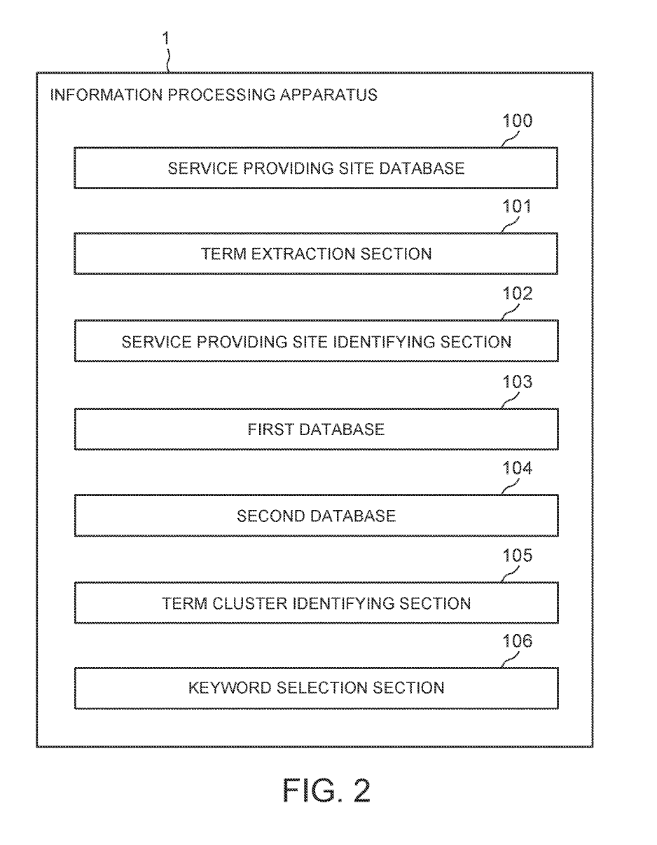

FIG. 2 is a functional block diagram of the information processing apparatus 1 according to the embodiment of the present invention. As illustrated in FIG. 2, the information processing apparatus 1 according to the present invention includes a service providing site database 100, a term extraction section 101, a service providing site identifying section 102, a first database 103, a second database 104, a term cluster identifying section 105, and a keyword selection section 106.

The service providing site database 100 and the databases 103, 104 included in the information processing apparatus 1 are databases generated by the CPU 10 performing predetermined processing on various pieces of information acquired through the network 200. The generated databases are stored, for example, in the HDD 12 in a nonvolatile manner. The details of the “service providing site database 100,” the “first database 103,” and the “second database 104” to be stored will be described in detail later.

The service providing site database 100 of the information processing apparatus 1 is configured to include terms, in the form of words, appearing on service providing sites that provide commercial products, services, or information via the network 200. Note that the “terms” in the embodiment means all general words appearing in text and the like acquired via the service providing sites and the network 200. In the following description, words appearing in a viewing document and words that constitute a database are referred to as terms with no exception.

Here, in the embodiment, examples of service providing sites include: “Google” (registered trademark) and “Yahoo” (registered trademark) known as search engines; “Gurunavi” (registered trademark), “Tabelog” (registered trademark), “Yelp” (registered trademark), and “Hotpepper” (registered trademark) as sites to introduce information to users; and “Amazon” (registered trademark), “Rakuten” (registered trademark), and “iTunes” (registered trademark) as EC sites to provide contents or commercial products to users through online electronic transactions, but the present invention is not limited to these examples. It is assumed that even any site other than the above-mentioned sites corresponds to a service providing site of the embodiment as long as the site is to provide, to users, commercial products, services, or information. The above-mentioned service providing sites are accessed via the network 200 to make a database of acquired information in a predetermined system and store the information.

For example, a so-called clustering system is an example of the predetermined system to make the database, in which text that constitutes each acquired service providing site is morphologically analyzed to decompose the text into terms and extract the terms, and terms similar in appearance tendency among the extracted terms are grouped, but the present invention is not limited to this system. The text that constitutes the acquired service providing site is morphologically analyzed to decompose the text into terms and extract the terms, and the extracted terms and appearance frequencies as feature values for the service providing site are stored. Further, predetermined words may be preset as specific terms for each service providing site (for example, words associated with commercial products such as “TV set,” and “Desk” for an EC site to provide commercial products, words associated with cuisine such as “Chinese” and “Italian” for a gourmet site to provide information on restaurants and the like to users, etc.) to list the specific terms for each service providing site. Further, the terms extracted from the service providing site may be limited only to words that make sense alone, such as nouns and proper nouns, and nouns low in feature such as date and time may be excluded.

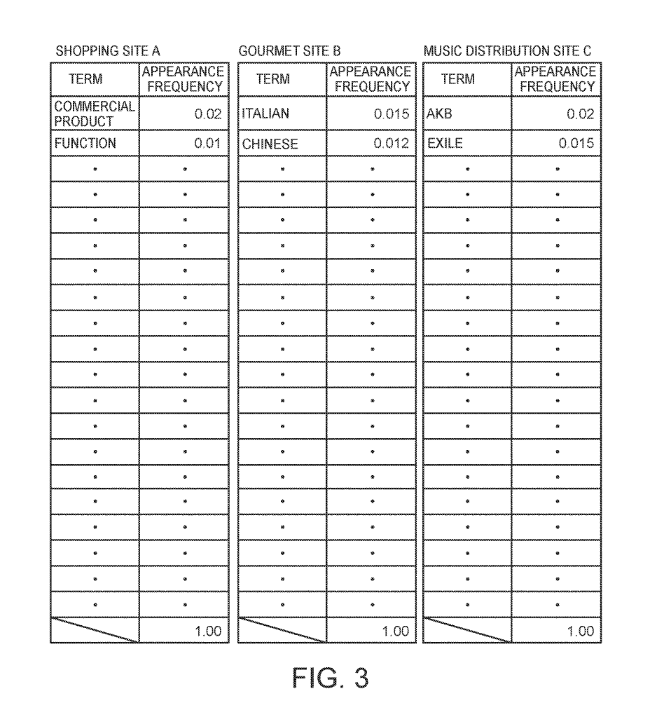

An example of the service providing site database 100 is illustrated in FIG. 3. In the embodiment, three service providing sites “Shopping Site A,” “Gourmet Site B,” and “Music Distribution Site C” are taken as examples. For example, the “Shopping Site A” is made up mainly of terms associated with commercial products such as “Commercial Product” and “Function.” Further, the appearance frequency means the appearance rate of a predetermined term with respect to the number of appearances of all terms that constitute each service providing site. For example, the term “Commercial Product” appears at an appearance rate of 0.02 with respect to the number of appearances of all the terms. The service providing site database 100 is also generated for the “Gourmet Site B” and the “Music Distribution Site C” in the same manner as for the “Shopping Site A.”

The service providing site database 100 of the information processing apparatus 1 is generated by the CPU 10 reading and executing a program in which the predetermined database system stored in the memory 11 is written. The generated database is stored in a storage device such as the HDD 12.

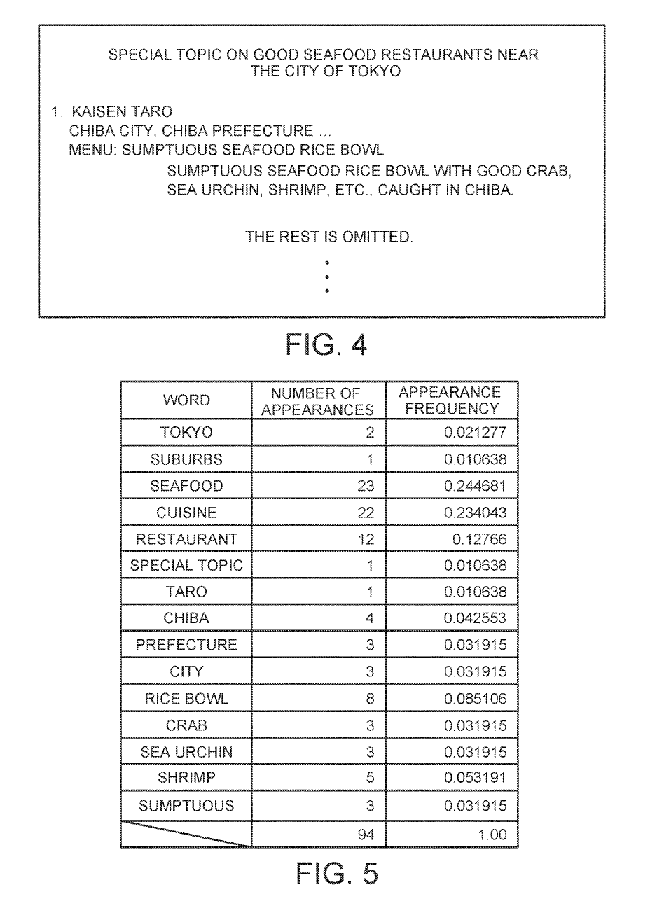

The term extraction section 101 of the information processing apparatus 1 extracts terms from a viewing document being viewed by a user. The “viewing document” here means text data acquired via the network 200 based on a certain operation on a computer or by the user. Referring to FIG. 4, the term extraction section 101 will be described in detail. FIG. 4 is a diagram illustrating an example of the viewing document acquired via the network 200. Thus, terms are extracted from many pieces of text that constitute the document. The terms are extracted by morphological analysis or the like.

FIG. 5 illustrates the results of extracting the terms from the viewing document in FIG. 4. Here, the terms are limited only to terms that make sense alone, such as nouns and proper nouns, and nouns low in feature such as date and time are excluded. Note that, although the number of appearances indicates how many times the predetermined term appears in the viewing document, the calculation can also be made as the appearance frequency and stored together, rather than the number of appearances, to keep in line with the service providing site database 100 in FIG. 3.

The term extraction section 101 of the information processing apparatus 1 can be implemented by the CPU 10 reading and executing a program for analyzing terms stored in the memory 11 and extracting the terms to store data after being subjected to arithmetic processing or the like temporarily in the memory 11, or store the data in the HDD 12 or the like.

The service providing site identifying section 102 of the information processing apparatus 1 identifies a service providing site associated with the viewing document based on the feature values of the terms extracted from the viewing document included in the service providing site database 100. The details of an embodiment of identifying the service providing site will be described in detail below.

### First Embodiment of Identifying Service Providing Site

First, FIG. 4 is used as an example of the viewing document. A service providing site associated with the viewing document in FIG. 4 is identified from data obtained by morphological analysis as illustrated in FIG. 5. Note that identification targets are three service providing sites, “Shopping Site A,” “Gourmet Site B,” and “Music Distribution Site C” in FIG. 3. Information corresponding to each of terms appearing in the viewing document is extracted from the service providing site database 100 in FIG. 3. In other words, when a term corresponding to the data extracted by morphological analysis as in FIG. 5 exists in the database for each service providing site, the term and information on the appearance frequency are extracted.

As one of the criteria of identifying a service providing site associated with the viewing document, there is a method of evaluating the similarity between the viewing document and each service providing site to identify a service providing site based on the evaluation results. It is assumed that a degree of cosine similarity based on the appearance frequency of each of the terms that constitute the text is used in the embodiment as one of evaluation criteria used in evaluating the similarity. As the first embodiment of identifying a service providing site, the similarity between each term appearing in the viewing document and the term appearing on each service providing site is evaluated.

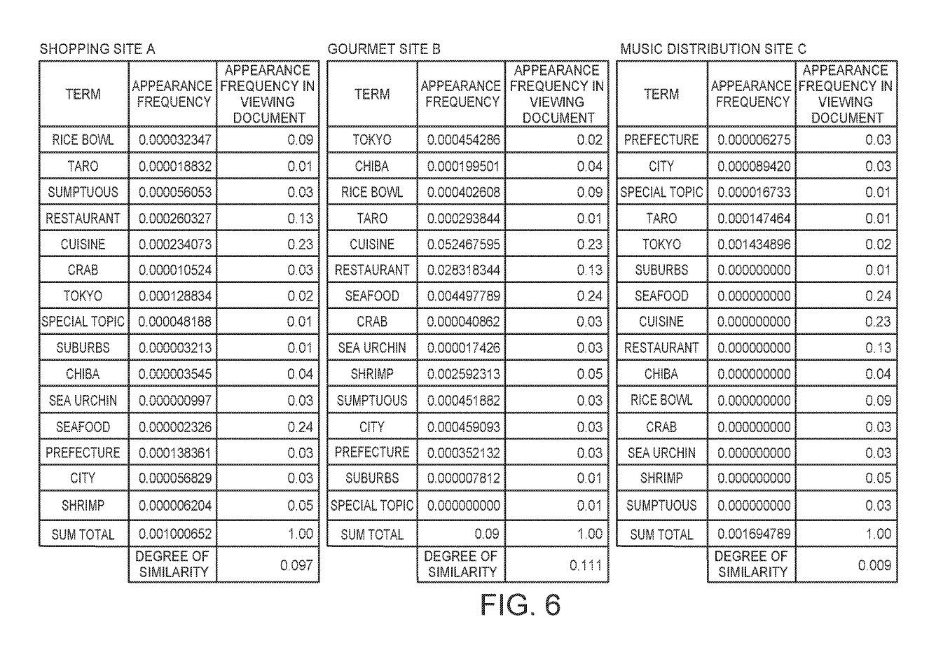

Based on the results of extracting the terms from the viewing document as illustrated in FIG. 5, the database of each service providing site in FIG. 3 is extracted by focusing only on the terms appearing in the viewing document of FIG. 4. The extraction results are illustrated in FIG. 6. The appearance frequency in FIG. 6 indicates the appearance rate of a specific term with respect to the number of appearances of all terms on each service providing site. Note that a term that appears in the viewing document of FIG. 4 but does not appear in the service providing site database 100 of FIG. 3 is set as “No Appearance,” that is, to “0” as the appearance frequency.

As a calculation method for the degree of cosine similarity, the appearance frequency of each term appearing in the viewing document and the appearance frequency of the term appearing on each service providing site are taken as vector components, respectively, to calculate the inner product of vector components of the same term. Since the calculation method for the degree of cosine similarity is known (for example, see Japanese Patent Application Publication No. 2015-197722), the description of the detailed calculation procedure will be omitted. Using such a calculation method, the degrees of similarity are calculated to be 0.097 for the “Shopping Site A,” 0.111 for the “Gourmet Site B,” and 0.009 for the “Music Distribution Site C.”

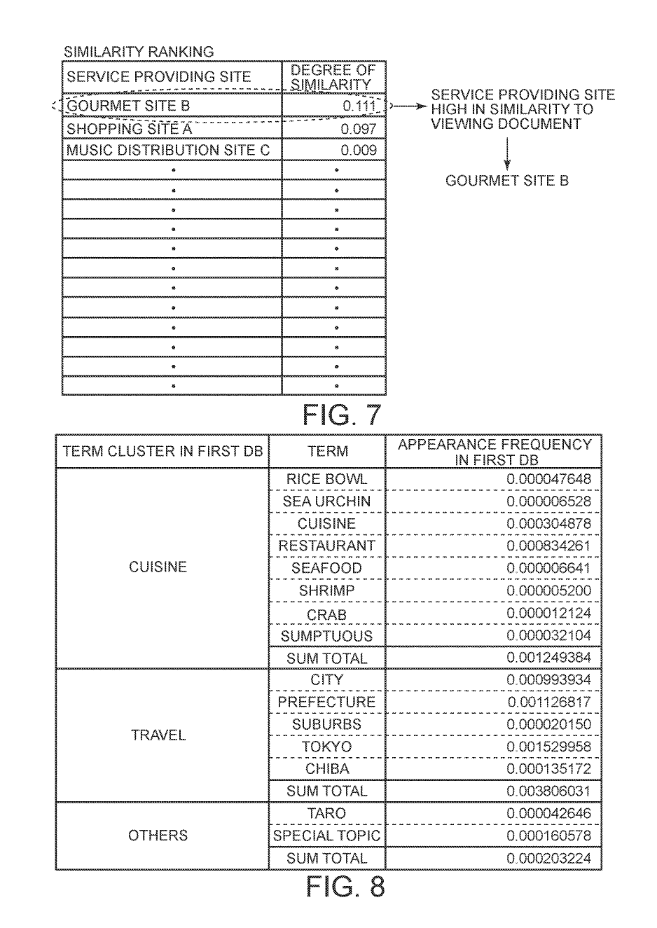

The results calculated for each service providing site are illustrated in FIG. 7. As a result, 0.111 calculated for the “Gourmet Site B” is the largest value. The maximum value as the definition of the degree of cosine similarity, i.e., the highest value in similarity is 1, and this value indicates that comparison targets agree completely. In other words, it can be said that the similarity is higher as the calculated result is closer to 1. Thus, the service providing site highest in similarity to the viewing document can be identify as the “Gourmet Site B.” Note that the calculation of the degree of similarity is not limited to the degree of cosine similarity, and the concept of the Euclidean distance may be used. Further, when attention is focused on the appearance frequency, for example, there is such an idea to identify a service providing site on which the appearance frequency of a term corresponding to a word extracted from the viewing document is high and the appearance frequency of any term other than the word extracted from the viewing document is low. The similarity can be evaluated by introducing the concept of high/low scoring for each term such as to add a plus point to a term appearing on the service providing site and add a minus point to a term that does not appear on the service providing site when attention is focused on certain terms extracted.

In the above, an example of identifying a service providing site associated with the viewing document based on each term appearing on the service providing site and the appearance frequency of the term appearing on the service providing site is described. As another example, the service providing site database 100 may be, for example, clustered based on the similarity in appearance frequency of each term appearing on the service providing site. Since terms are grouped based on the similarity in appearance frequency, “Seafood” such as “Crab, “Sea Urchin, and “Shrimp” appearing in the viewing document may belong to the same group. Therefore, the similarity of each group of terms to the viewing document can be evaluated to identify the service providing site.

The service providing site identifying section 102 of the information processing apparatus 1 can be implemented by the CPU 10 reading and executing databases or the like stored in the HDD 12 based on a predetermined service providing site identifying program stored in the memory 11 to store data after being subjected to arithmetic processing or the like temporarily in the memory 11, or store the data in the HDD 12 or the like.

The first database 103 of the information processing apparatus 1 is a two-dimensional database configured to include term clusters obtained by morphologically analyzing terms, in the form of words, appearing in documents accessible via the network 200 and grouping terms based on the appearance frequencies of the terms with respect to the documents, and document clusters obtained by grouping documents similar in term appearance tendency. The first database 103 may be a one-dimensional database composed only of terms grouped based on the appearance frequencies with respect to the documents. The “documents” here means a wide variety of information viewable by many and unspecified persons. For example, the documents may include information on sites to distribute social articles on politics and economics, and the like, and information on sites to distribute sports articles. The documents may also include search engines mentioned above, sites to introduce information to users, and service providing sites such as EC sites. The details of the “term clusters” mentioned above will be described later.

For example, as the predetermined system to make the database, there is a so-called clustering system in which text that constitutes an acquired document is morphologically analyzed to decompose the text into terms and extract the terms so as to group terms similar in appearance tendency. Thus, since grouping is done based on the terms similar in appearance tendency, terms specific to the same specific category belong to the same group. For example, as an example of clustering results, terms associated with baseball such as “Yomiuri Giants” and “Hanshin Tigers,” and terms associated with politics such as “Democratic Liberal Party” and “Cabinet” belong to the same groups, respectively. Thus, a group of terms similar in appearance tendency is defined as a term cluster. In the embodiment, terms to be grouped are limited to the terms appearing in the viewing document of FIG. 4 for the sake of simplification. In FIG. 8, cooking ingredients such as “Sea Urchin,” “Seafood,” and “Shrimp,” terms associated with menus, and the like belong to a term cluster called “Cuisine,” and terms associated with place names such as “Tokyo” and “Chiba” belong to a term cluster called “Travel.” Note that terms that do not belong to the above two term clusters, such as “Taro” and “Special Topic,” are put in a term cluster “Others” for convenience sake.

The first database 103 of the information processing apparatus is generated by the CPU 10 reading and executing the program in which the predetermined database system stored in the memory 11 is written. The generated database 103 is stored in a storage device such as the HDD 12.

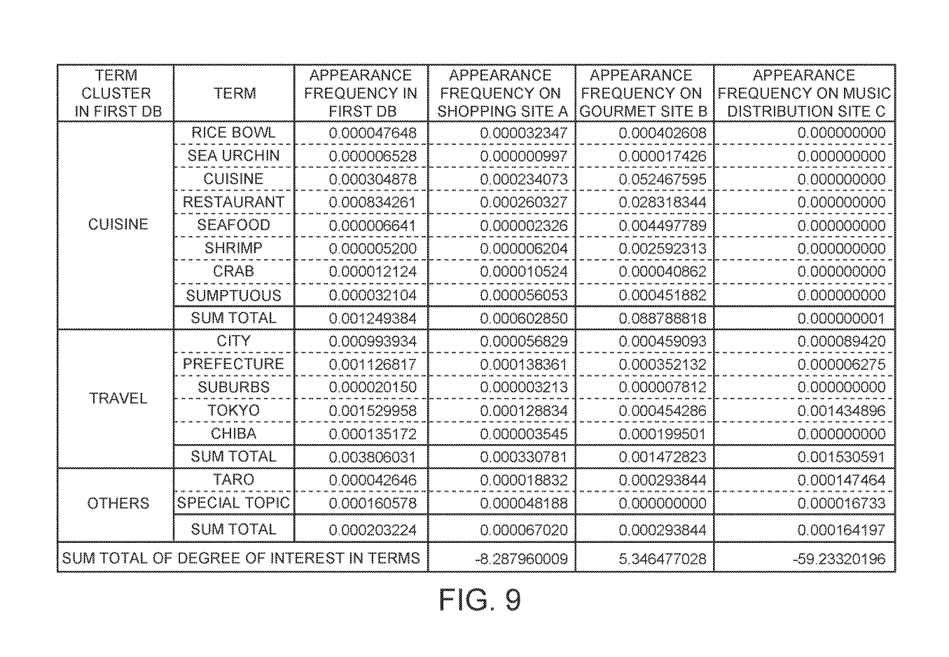

The second database 104 of the information processing apparatus 1 is so configured that the appearance frequency of each term appearing on a service providing site that provides commercial products, services, or information via the network 200 is associated with the appearance frequency of the term appearing in the first database. When the first database 103 is a two-dimensional database as mentioned above, the second database 104 is configured to associate the appearance frequency of each term appearing on the service providing site with the appearance frequency of the term appearing in the first database 103, and further to associate the service providing site with each document cluster in the first database 103 from the appearance tendency of each term appearing on the service providing site. An example of the second database is illustrated in FIG. 9. FIG. 9 is a table in which each term appearing in the first database 103 is associated with each service providing site corresponding to the term. In the embodiment, the three service providing sites are listed side by side as one database for the sake of simplification, but a database associated with the first database 103 may be provided for each service providing site. Thus, a database associated with term information on each service providing site based on the clustering of the first database 103 is defined as the second database 104. Note that an effective range of various pieces of information on each service providing site may be all pieces of information including all terms, may be limited to sampling information obtained by extracting only some pieces of information at random, or may be limited to popular information high in the ranking of user accesses or the like. In any case, it is preferred to focus only on a certain amount of information, rather than to see all pieces of information on the service providing site, in consideration of the load required to calculate the appearance frequencies of terms.

The second database 104 of the information processing apparatus 1 is generated by the CPU 10 reading and executing the program in which the predetermined database system stored in the memory 11 is written. The generated database 104 is stored in a storage device such as the HDD 12.

### Second Embodiment of Identifying Service Providing Site

Next, a second embodiment of identifying a service providing site will be described. Like in the first embodiment, FIG. 4 is used as an example of the viewing document. Then, the second database 104 in FIG. 9 is used as the database for a service providing site to be identified. FIG. 9 is configured to associate each term appearing in the viewing document with the appearance frequency of the term on each service providing site based on the first database 103 generated as mentioned above.

The criterion of identifying a service providing site in the second embodiment is to determine the service providing site from a degree of service interest calculated from a correlation between the appearance frequencies of terms appearing in documents accessible via the network 200 and the appearance frequencies of the terms appearing on each service providing site in the second database 104. In other words, it is determined how much the appearance frequencies on each service providing site are highly characteristic with respect to those in the documents accessible via the network 200. In the embodiment, the determination is made with reference to the terms appearing in the viewing document. When the appearance frequency of each term appearing in the viewing document with respect to that in the documents accessible via the network 200 is denoted by S, and the appearance frequency of the term appearing in the viewing document with respect to that on each service providing site is denoted by T, the degree of service interest can be calculated as LOG(T/S). This degree of service interest is calculated for each term, and summed up for each service providing site to evaluate how much each service providing site is highly characteristic with respect to the documents accessible via the network. According to this calculation method, for example, the value of the appearance frequency of each term appearing in the viewing document is larger and hence the degree of service interest is higher than that in the documents accessible via the network 200 as the appearance frequency of the term on the service providing site increases, and in the reverse case, the value becomes a minus trend and hence determined to be low in the degree of service interest. In other words, a service providing site high in the degree of service interest is determined to be a service providing site highly characteristic in the viewing document, and hence can be identified as a service providing site high in relevance.

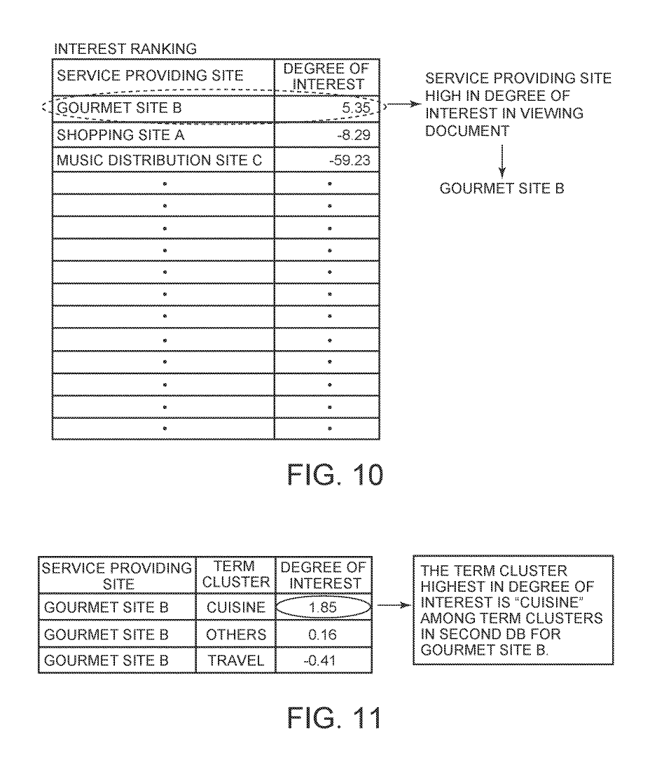

As mentioned above, when the degrees of service interest calculated for respective terms are summed up for each service providing site, the sum total is 5.35 for the “Gourmet Site B,” −8.29 for the “Shopping Site A,” or −59.23 for the “Music Distribution Site C” as illustrated in FIG. 10. In other words, from a standpoint of the degree of service interest, the “Gourmet Site B” can be identified as the service providing site having the highest relevance to the viewing document among the three service providing sites. As the method of evaluating each service providing site, it is also possible to calculate a degree of interest in each term cluster to sum up the degrees of interest in each term cluster on each service providing site to make an evaluation, rather than to calculate a degree of service interest for each term and sum up the degrees of interest.

The term cluster identifying section 105 of the information processing apparatus 1 identifies a term cluster associated with the viewing document based on the terms extracted from the viewing document. Using the second database 104 in FIG. 9 to identify a term cluster, description will be made below. As a determination criterion for identifying a term cluster, for example, the idea of the degree of interest can be used like in the second embodiment of identifying a service providing site. The degree of interest is calculated for each term cluster in the second database 104 for each service providing site in the same manner as mentioned above to identify a term cluster with the highest degree of interest as a term cluster associated with the viewing document. In the embodiment, a term cluster is identified from the second database 104 for the “Gourmet Site B” on the assumption that the service providing site associated with the viewing document is identified as the “Gourmet Site B” in the second embodiment of identifying a service providing site.

As the calculation method for identifying a term cluster on the “Gourmet Site B,” the degree of interest in the term cluster can be calculated as LOG(T′/S′) when the sum total of the appearance frequencies of each term cluster in the documents accessible via the network 200 is denoted by S′, and the sum total of the appearance frequencies of the terms of each term cluster appearing in the viewing document for each service providing site is denoted by T′. The feature value thus calculated is defined as the “degree of interest in the term cluster.” If T′ is small and S′ is large, the calculated degree of interest in the term cluster will be low. Here, it is ideal to identify a term cluster particularly high in degree of interest in the term cluster as the term cluster associated with the viewing document.

As mentioned above, when the degrees of interest in respective term clusters “Cuisine,” “Travel,” and “Others” are calculated, “Cuisine” is 1.85, “Others” is 0.16, and “Travel” is −0.41 as illustrated in FIG. 11. In other words, from a standpoint of the degree of interest in a term cluster, the term cluster having the highest relevance to the viewing document among the term clusters in the second database 104 for the “Gourmet Site B” can be identified as “Cuisine” as in FIG. 9.

The term cluster identifying section 105 of the information processing apparatus 1 can be implemented by the CPU 10 reading and executing databases or the like stored in the HDD 12 based on a predetermined term cluster identifying program stored in the memory 11 to store data after being subjected to arithmetic processing or the like temporarily in the memory 11, or store the data in the HDD 12 or the like.

As described above, in the first embodiment, a service providing site associated with the viewing document is identified based on the service providing site database 100, i.e., the appearance frequencies on the service providing site, while in the second embodiment, a service providing site associated with the viewing document is identified based on the second database 104, i.e., the correlation between the appearance frequencies in the documents accessible via the network 200 and the appearance frequencies on the service providing site. Although the databases are in different formats, the service providing site associated with the viewing document can be identified as the “Gourmet Site B” based on the appearance tendencies of the terms appearing in the viewing document.

The keyword selection section 106 of the information processing apparatus 1 selects, from the identified term cluster, a keyword as a term associated with the viewing document. Suppose that a keyword to acquire a commercial product, a service, or information from a service providing site after the service providing site associated with the viewing document is identified.

<Embodiment of Selecting Keyword>

An embodiment of selecting a keyword associated with the viewing document will be described. First, it is assumed that FIG. 4 is used as an example of the viewing document while taking over the contents used to identify a service providing site, and then, the service providing site associated with the viewing document is identified as the “Gourmet Site B” by the service providing site identifying section 102. It is further assumed that the information processing apparatus 1 includes a third database (not illustrated) to store each of the terms appearing in the first database based on the appearance frequency of the term appearing in documents acquired via the network 200 in the past by a client, for example, who owns the information processing apparatus 1 so as to associate the degree of interest on the client side with that in the first database. Note that the documents used to associate the degree of interest on the client side with the third database include documents acquired and viewed in the past via the network 200 by an individual user, for example, who owns the information processing apparatus 1, and documents acquired from social networking services (SNSs) such as Twitter (registered trademark) that allow many and unspecified users to say something freely and post web links to socially prevailing information.

When a keyword is selected from among terms belonging to the term cluster “Cuisine” identified as the term cluster associated with the viewing document, the keyword is selected based on the degree of interest on the client side stored in the third database mentioned above, and the degree of service interest in the service providing site mentioned above. As an example of the method of evaluating each term to select a keyword, a corrected degree of interest corrected by multiplying the degree of interest on the client side by the degree of service interest in the service providing site and the number of appearances in the viewing document to correct the degree of interest on the client side is evaluated. This takes the features of the service providing site into consideration more than conventional keyword selection based on the degree of interest on the client side, and hence a term appropriate for the viewing document can be selected as a keyword by adding the features of the service providing site.

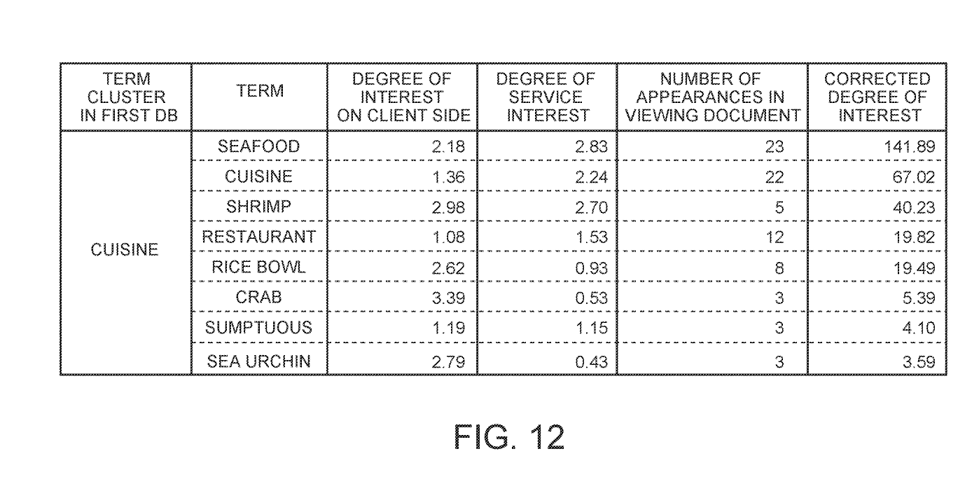

As an example of keyword selection in the embodiment, a keyword associated with the viewing document is selected based on the corrected degree of interest obtained by multiplying the degree of interest on the client side by the degree of service interest in the service providing site and the number of appearances in the viewing document to correct the degree of interest on the client side as illustrated in FIG. 12. A term highest in the corrected degree of interest is “Seafood,” and the term “Seafood” is selected as the keyword associated with the viewing document. Since the term “Seafood” is the highest value obtained by multiplying the degree of interest on the client side by the degree of service interest in the service providing site and the number of appearances in the viewing document, it can be said that the term is appropriate as the keyword associated with the viewing document.

The parameter of the degree of service interest in the service providing site used in an arithmetic expression to correct the degree of interest on the client side is not limited to the value of the degree of service interest itself as mentioned above. For example, it may be a parameter as a radical root such as the square root or cube root of the degree of service interest in the service providing site. In any case, the arithmetic expression is not limited to that mentioned above as long as the feature of each term on the service providing site can be corrected to reflect the feature of the term on the service providing site in the degree of interest on the client side. Further, the number of appearances in the viewing document used to calculate the corrected degree of interest may be the number of actual appearances in the viewing document, or an appearance frequency as the number of appearances of each term calculated from the number of appearances of all terms appearing in the viewing document may be used. Any of the parameters may be used as long as the appearance tendency of each term appearing in the viewing document can be weighted.

<Anther Embodiment of Selecting Keyword>

Any embodiment other than that of correcting the degree of interest on the client side using the degree of service interest in the service providing site will be described. In the first embodiment, the degree of service interest is calculated based on the second database 104. However, for example, the degree of service interest calculated based on the service providing site database 100 may be applied. Since the service providing site database 100 is generated by clustering based directly on the service providing sites, each term which is specific to each service providing site but does not appear in the first database 103 can be covered.

The keyword selection section 106 of the information processing apparatus 1 can be implemented by the CPU 10 reading and executing databases or the like stored in the HDD 12 based on a predetermined keyword selecting program stored in the memory 11 to store data after being subjected to arithmetic processing or the like temporarily in the memory 11, or store the data in the HDD 12 or the like.

As described above, a term high in relevance to the viewing document can be selected as a keyword.

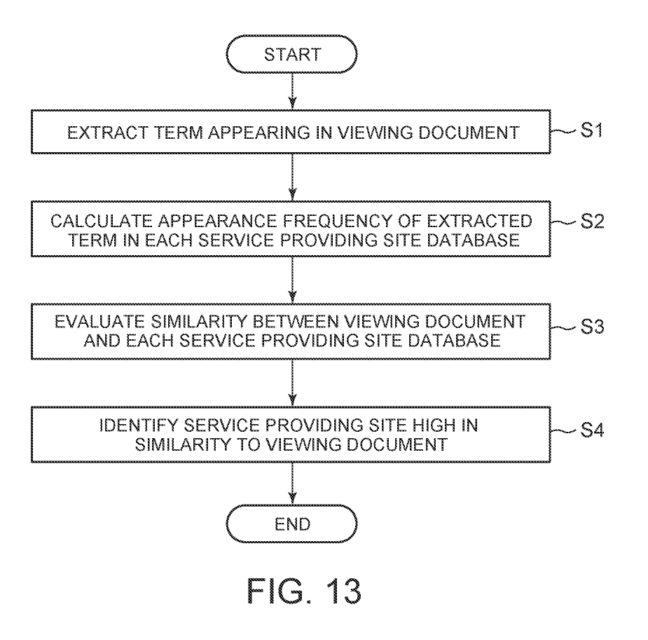

FIG. 13 is an example of a flowchart of the service providing site identifying section according to the embodiment of the present invention.

First, each term appearing in the viewing document is extracted (step 1). The appearance frequency of the extracted term in each service providing site database 100 is calculated (step 2). The similarity between the viewing document and each service providing site database 100 is evaluated (step 3). A service providing site high in similarity to the viewing document is identified (step 4).

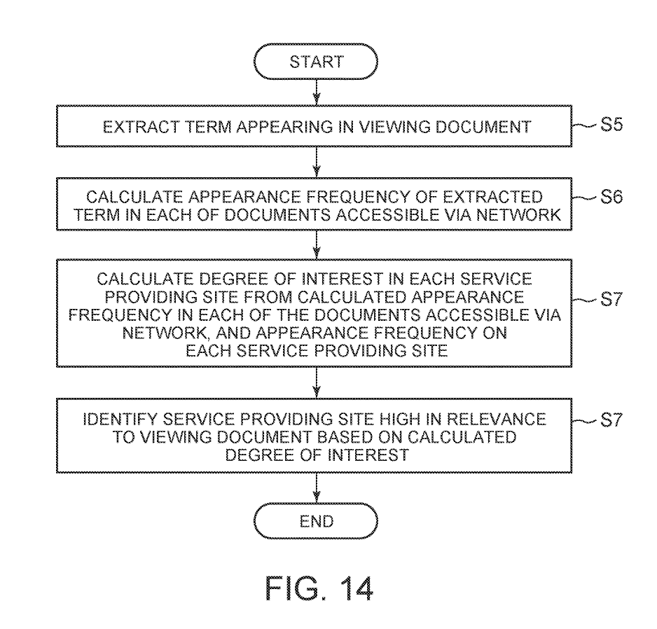

FIG. 14 is another example of a flowchart of the service providing site identifying section according to the embodiment of the present invention.

First, each term appearing in the viewing document is extracted (step 5). The appearance frequency of the extracted term in each of the documents accessible via the network 200 is calculated (step 6). From the calculated appearance frequency in each of the documents accessible via the network 200, and the appearance frequency on each service providing site, the degree of interest in each service providing site is calculated (step 7). Based on the calculated degree of interest, a service providing site high in relevance to the viewing document is identified (step 8).

Note that the contents equipped in an apparatus used and the number of apparatuses are not limited to those in the embodiment as long as the configuration can carry out the present invention. For example, the configuration may include both the service providing site database 100 in FIG. 2 and the second database 104, or either of them.

We claim:

1. An information processing apparatus comprising:
a service providing site database configured to include terms, in the form of words, appearing on a service providing site that provides a commercial product, service, or information via a network;
a term extraction section that extracts each term from a viewing document being viewed by a user; and
a service providing site identifying section that identifies a service providing site associated with the viewing document based on a feature value stored in the service providing site database in association with each extracted term.

2. The information processing apparatus according to claim 1, wherein:
the service providing site database is composed of terms appearing on the service providing site, and an appearance frequency of each term appearing on the service providing site, and
the service providing site identifying section identifies the service providing site associated with the viewing document based on the appearance frequency stored in the service providing site database in association with each extracted term.

3. The information processing apparatus according to claim 1, wherein:
the service providing site database is configured so that the terms appearing on the service providing site are grouped based on similarities of appearance frequency, and
the service providing site identifying section identifies the service providing site associated with the viewing document based on the appearance frequency of each term stored in the service providing site database in association with the extracted terms.

4. An information processing apparatus comprising:
a first database that stores a term cluster in which terms, in the form of words, appearing in documents accessible via a network are grouped based on appearance frequencies of the terms in the documents;
a term extraction section that extracts each term from a viewing document being viewed by a user;
a second database that stores an appearance frequency of each extracted term appearing on a service providing site, which provides a commercial product, service, or information via the network, in association with an appearance frequency of the term appearing in the first database with respect to the documents accessible via the network; and
a service providing site identifying section that identifies a service providing site associated with the viewing document based on the appearance frequency of each extracted term in the first database with respect to the documents accessible via the network.

5. The information processing apparatus according to claim 4, further comprising:
a third database that stores a term appearing in the first database in association with a first degree of interest of the user or general public;
a term cluster identifying section that identifies the term cluster associated with the viewing document based on each extracted term; and
a keyword selection section that selects a keyword as a term associated with the viewing document from the identified term cluster.

6. The information processing apparatus according to claim 5, wherein the keyword selection section selects, from among terms belonging to the identified term cluster, a keyword as a term associated with the viewing document based on the first degree of interest of the user or the general public, and a second degree of interest in the term appearing on the service providing site, which is calculated based on a correlation between the appearance frequency of the term in the documents accessible via the network, and the appearance frequency of the term on the service providing site.

7. The information processing apparatus according to claim 6, wherein the keyword selection section selects, from among the terms belonging to the identified term cluster, a keyword as a term associated with the viewing document based on a corrected degree of interest corrected by multiplying the first degree of interest by the number of appearances of the term in the viewing document and the second degree of interest.

8. An information processing method comprising:
generating a first database that stores a term cluster in which terms, in the form of words, appearing in documents accessible via a network are grouped based on appearance frequency;
extracting each term from a viewing document being viewed by a user;
generating a second database that stores an appearance frequency of each extracted term appearing on a service providing site, which provides a commercial product, service, or information via the network, in association with an appearance frequency of each term appearing in the first database with respect to the documents accessible via the network; and
identifying a service providing site associated with the viewing document based on the appearance frequency of each extracted term in the first database with respect to the documents accessible via the network.
